(19) United States
(12) Patent Application Publication
(10) Pub. No.: US 2017/0326835 A1
(43) Pub. Date: Nov. 16, 2017

(54) BREATHABLE LAMINATE HOUSEWRAP AND UNDERLAYMENT

(71) Applicant: Innovative Construction Materials (H.K.) Ltd., Beijing (CN)

(72) Inventor: Wang Xiang Li, Shanghai (CN)

(21) Appl. No.: 15/152,588

(22) Filed: May 12, 2016

(51) Int. Cl. B32B 5/26; B32B 7/12; B32B 5/02

(52) U.S. Cl. CPC B32B 5/26; B32B 5/028; B32B 7/12; B32B 5/022; B32B 2307/5825; B32B 2262/0253; B32B 2255/02; B32B 2307/724; B32B 2419/04; B32B 2419/06; B32B 2262/0276

(57) ABSTRACT

Portions of various buildings or edifices, including the roof and walls, can be protected from water using a flexible and water vapor permeable laminate. The laminate includes a non-woven layer providing a protective surface that is bonded to a woven scrim. The woven scrim provides substantial reinforcement to the laminate and is backed with a tacky layer to make the laminate resistant to sliding or stretching across an installation surface. The layers of the laminate each contribute to the water vapor permeability, where a bonding layer joining the non-woven layer and the scrim layer, as well as the tacky layer, can each include pores allowing water vapor therethrough.

### FIELD

The present technology relates to a breathable and water vapor permeable laminate, including where the laminate is particularly adapted for housewrap and underlayment applications.

### INTRODUCTION

This section provides background information related to the present disclosure which is not necessarily prior art.

Buildings, including residential and commercial structures, typically have a frame, a sheathing material over the frame, and an exterior building covering over the sheathing material. A housewrap is often included, where the housewrap is typically placed between the sheathing material and the exterior building covering to serve as a secondary moisture barrier and inhibit water intrusion into the building. Housewraps can also inhibit air intrusion into the building to help to prevent energy loss and mitigate climate control issues. For example, inner sheathing members of a wall and/or roof are covered with various types of building paper, tar paper, roofing felt, housewrap material, and the like to provide a weather barrier to help block the penetration of air and/or water into the building through an exterior wall or roof A housewrap made of thermoplastic materials can also be designed to be water vapor permeable, allowing water vapor to escape through the exterior wall or roof. Examples of thermoplastic housewrap materials include Tyvek™ HomeWrap, available from DuPont (Wilmington, Del.), and Typar™ HouseWrap, available from BBA Fiberweb (Old Hickory, Tenn.).

In both residential and commercial roofing applications, a roofing material is used to provide a weather and water protection barrier. Various roofing materials include composite shingles, metal panels or shingles, concrete or clay tiles, wood shakes, slate, concrete and clay tile, and the like. In certain circumstances, water can penetrate the roof cladding material due to a primary roofing material design, installation practices, or an accidental breach of the primary roof cladding. To protect the building interior in these circumstances, a layer called a roofing underlayment can be provided beneath the layer of roof cladding. The roofing underlayment acts as a secondary water and moisture barrier. Underlayment can be affixed to a solid roof deck surface, for example, by use of various fasteners such as nails, staples, and the like, or through use of an adhesive. The underlayment can be substantially impermeable to moisture. Additionally, it is desirable for the underlayment to have high tensile and tear strengths to reduce the likelihood of tearing during installation and exposure to high winds. Underlayment can preferably be light in weight to facilitate ease of transport and application, and should be able to withstand prolonged exposure to sunlight, air, and water.

Base sheet underlayment for various roof applications include traditional asphalt saturated or “tar paper” felt materials. Although widely used, these felt materials are associated with numerous drawbacks that can diminish the integrity of the roof system. For example, felt absorbs moisture causing physical expansion where the material will buckle and wrinkle. Water can contact felt during installation due to weather exposure and felt can also absorb water after installation, where moisture from inside the structure is generated from various sources, such as cooking, showers, industrial processes, etc. The buckling and wrinkling condition causes felt to load up on any fasteners employed, causing tears or elongation of the felt at the fastener, which can compromise the integrity of the roof system. Felt containing moisture can also support growth of mold and fungus. What is more, felt has no natural protection from UV light and can deteriorate when left exposed to direct solar radiation.

Polymeric roof underlayment materials, such as various polyolefin materials, are available that provide a significant improvement over standard felts. Such synthetic polyolefin materials offer optimum levels of tensile strength, light weight, and improved handling characteristics. Typically a woven or non-woven polyolefin material is coated on either one or both sides with a polymer coating. The polymer composition of the woven material and coating are normally a variation or combination of polyethylene or polypropylene. These polyolefin materials provide several benefits in that they are inert and do not absorb moisture or breakdown when exposed to harsh outdoor elements or chemicals. They can be resistant to rot and can have greatly improved UV resistance in comparison to felt.

Liquid water can sometimes get behind an exterior building cladding, such as various exterior building coverings, sidings, and roofing materials, through cracks or seams in the exterior building covering, roofing material, or through various fixtures including window and door joints. What is more, moisture from the relatively warm side of the building envelope can penetrate through the sheathing material and the housewrap and can condense into liquid water upon contacting a relatively cold building covering surface. Liquid water can subsequently become trapped in the wall or roof envelope and may cause water damage. Trapped water can also encourage growth of mold and mildew, which in turn can cause degradation of building components and health concerns.

### SUMMARY

The present technology includes articles of manufacture, methods of manufacture, and methods of use that relate to a flexible and water vapor permeable laminate that can be used in various building and construction applications, including housewrap and roofing underlayment applications.

A laminate is provided that includes a non-woven layer, a bonding layer contacting the non-woven layer, a scrim layer contacting the bonding layer, and a tacky layer contacting the scrim layer. The laminate is flexible and permeable to water vapor, allowing a portion of a structure covered with the laminate to breathe. The bonding layer can include a first coating layer, a second coating layer, and a tie layer, where the tie layer is positioned intermediate the first coating layer and the second coating layer. The tie layer can be configured as a second non-woven layer or can include a second non-woven layer. The scrim layer can provide the majority of the structural stability of the laminate, where the scrim layer can be more resistant to tearing and stretching than the non-woven layer. The tacky layer can make the laminate resistant to sliding or stretching when the laminate is placed in contact with a surface, such as a portion of a roof and/or a wall of a structure. The tacky layer can include pores therethrough in order to maintain the water vapor permeability of the laminate. The laminate can have a surface density from about 100 grams per square meter to about 200 grams per square meter. Flexibility of the laminate allows installation over various surface shapes and textures. The laminate can be coupled to a portion of the structure in order to protect the structure and can be used in the same capacity as a housewrap and/or an underlayment.

Further areas of applicability will become apparent from the description provided herein. The description and specific examples in this summary are intended for purposes of illustration only and are not intended to limit the scope of, the present disclosure.

### DRAWINGS

The drawings described herein are for illustrative purposes only of selected embodiments and not all possible implementations, and are not intended to limit the scope of the present disclosure.

FIG. 1 illustrates a cross-sectional view of an embodiment of a laminate that is flexible and permeable to water vapor constructed in accordance with the present technology.

FIG. 2 illustrates the laminate coupled to a portion of a roof and a portion of a wall of a structure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. Except where otherwise expressly indicated, all numerical quantities in this description are to be understood as modified by the word “about” and all geometric and spatial descriptors are to be understood as modified by the word “substantially” in describing the broadest scope of the technology.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

The present technology provides a flexible and breathable laminate that can be used to protect a structure. In particular, the laminate can be used as a housewrap and/or a roofing underlayment. The laminate can include a non-woven layer, a bonding layer contacting the non-woven layer, a scrim layer contacting the bonding layer, and a tacky layer contacting the scrim layer, where the laminate is flexible and permeable to water vapor. As the entirety of the laminate is flexible and permeable to water vapor, each of the layers of the laminate can be flexible and each of the layers can contribute to the water vapor permeability. The laminate can be provided in various sizes and shapes, including strips, perforated sheets, precut sheets, and spirally wound rolls. By flexible, it is understood that the laminate can be readily wound into a roll and can be applied and follow changing surface contours and textures. For example, embodiments of the laminate can be bent and/or creased to follow angles of a structure when applied thereto. Other embodiments include laminate having the flexibility to be folded back upon itself By permeable to water vapor, it is understood that the laminate can provide a certain moisture vapor transmission rate (MVTR). For example, embodiments include where the laminate has an MVTR of at least about 35 grams per square meter per day to at least about 1000 grams per square meter per day. The laminate can also be configured in various weights, where in certain embodiments, the laminate can be configured to have a surface density from about 100 grams per square meter to about 200 grams per square meter. The laminate can further be wound and provided as a roll, where this configuration can facilitate storage as well as application of the laminate to a structure.

The flexible and breathable laminate can be formed in various ways, including pressing and/or heat laminating. Heat can be applied to one or more layers, a nip roll can join one or more layers together, and a chill roller can cool the layers and maintain the laminate structure. It is possible to form the laminate by sequential application of the various layers. In other embodiments, multi-layer portions of the laminate can be formed separately and then brought together to form the completed flexible and breathable laminate. It can be useful to provide the various layers as continuous webs that meet at certain points and under certain conditions to contact and couple the respective layers together. In this way, the laminate product can be formed as a continuous web and collected on a roll. Alternatively, sheets of the respective layers can be contacted and pressed together to assemble the laminate. The laminate may also be cut or shaped as desired for certain applications.

The non-woven layer can include one or more types of fibers bonded together by chemical, mechanical, heat, and/or solvent treatment. Such fibers or filaments can be entangled to form a sheet or web structure and bonded to provide the non-woven layer. The non-woven layer can include flat or tufted porous sheets that can be made from separate fibers, molten plastic, or plastic film. The non-woven layer can be mechanically perforated or may have sufficient space or holes between the entangled fibers to maintain water vapor permeability. By non-woven, it is understood that the the non-woven layer is not made by weaving or knitting and does not involve converting fibers to yarn, where the fibers or yarn are interlaced with a degree of regularity. The non-woven layer can be manufactured in several ways, including methods used in forming stable non-woven materials, melt-blown materials, spunlaid materials, and flashspun materials. For example, the non-woven layer can include a spun bonded fiber, sheets of spun bonded-melt blown-spun bonded fibers, a perforated polymer film, an expanded polymer film, a microporous polymer film, and/or a paper. In certain embodiments, the non-woven layer can include a polyolefin (e.g., polyethylene, polypropylene) and/or a polyester (e.g., polyethylene terephthalate).

The bonding layer can function to adhere and bond the non-woven layer to the scrim layer. In particular, the bonding layer can be necessary in forming and maintaining the laminate structure. The bonding layer can include one or more adhesives or resins, such as polyolefins, epoxy, polyurethane, cyanoacrylate, and acrylic polymers, including multicomponent adhesives such as polyester-polyurethane, polyol-polyurethane, and acrylic-polyurethane resins. The bonding layer can further maintain the permeability of the laminate to water vapor. This can be achieved by applying the bonding layer to the non-woven layer and/or the scrim layer in a manner that maintains a porosity in the bonding layer. For example, a compressed gas (e.g., air, carbon dioxide, nitrogen) can be injected into the bonding layer as the bonding layer is extruded onto the non-woven and/or scrim layer. Subsequent expansion of the compressed gas provides the bonding layer with a porosity and associated water vapor permeability. The bonding layer can include one or more polyolefins, tales, fillers, silicones, and/or UV stabilizers.

In certain embodiments, the bonding layer includes a first coating layer, a second coating layer, and a tie layer, where the tie layer is intermediate the first coating layer and the second coating layer. The first coating layer, for example, can be chemically and/or physically compatible with the non-woven layer and adhere thereto. The second coating layer, for example, can be chemically and/or physically compatible with the scrim layer and adhere thereto. The tie layer can serve to tie and bond the first coating layer and the second coating layer together and can be compatible with each. In this way, the bonding layer can allow lamination of a non-woven layer and a scrim layer formed of dissimilar materials and/or structures. The first coating layer, second coating layer, and tie layer can be applied in various ways in forming the laminate. For example, the first coating layer can be applied to the non-woven layer and the second coating layer can be applied to the scrim layer. The tie layer can then be applied to one or both of the first coating layer and the second coating layer, where the non-woven layer and the scrim layer are brought together with the first coating layer, the second coating layer, and the tie layer disposed in-between. The tie layer can also be configured as a second non-woven layer and can include the various aspects described herein for the non-woven layer. The tie layer can also include a second non-woven layer having the various aspects described herein for the non-woven layer. As described above, a compressed gas can be injected into one or more of these various layers to provide a resulting porosity and associated water vapor permeability. Examples of the first coating layer, the second coating layer, and the tie layer include acid functional adhesives, anhydride functional adhesives, ethylene vinyl acetate based adhesive polymers, acrylate polymers, and polyolefins, where each of the respective layers can further include one or more talcs, fillers, silicones, and/or UV stabilizers.

The scrim layer is a woven layer that can increase the overall strength of the laminate and in certain cases can substantially determine the overall resistance of the laminate to tearing and stretching. The reinforcement properties of the scrim layer can be tailored by the choice of material, the orientation of the weft and warp strands, strand diameter, one or more coatings applied to the strands, the denier of the strands used in forming the scrim, among other factors. In certain embodiments, the scrim layer can be formed of one or more polyolefins and/or polyesters. Strands of the scrim layer can have a surface thereof coated to tailor various properties, including chemical sensitivity, strength, color, UV resistance, etc. In some embodiments, the scrim layer is more resistant to tearing and stretching than the non-woven layer. For example, the non-woven layer may lack sufficient strength and be susceptible to tearing or stretching without the scrim layer adhered thereto by the intermediate bonding layer. The scrim layer, therefore, can generally reinforce the overall laminate. This can improve function of the laminate in instances where forces or impact may occur during installation of the laminate. For example, where the laminate is employed as a roofing underlayment, the scrim layer can make the laminate resistant to stretching and tearing from foot traffic during installation. The scrim layer of the laminate can also mitigate effects of stress on the laminate caused by sliding or rubbing of various overlay or cladding materials (e.g., roofing shingles, exterior building siding) during construction and effects and wear of weather exposure.

The tacky layer contacting the scrim layer can increase the friction between the laminate and an installation surface. For example, certain roofing underlayments and housewraps can be inherently slick based upon the natural properties of the materials used in the construction thereof This issue can be compounded in wet or humid environments and present installation issues related to the weather. The laminate of the present technology, however, includes the tacky layer to reduce movement of the laminate during and after installation. Foot traffic and/or sliding or rubbing of various overlay or cladding materials on the laminate can subject the laminate to forces that could cause the laminate to shift position or stretch. Out of position laminate could compromise effectiveness and present less than optimal protection. The tacky layer allows the laminate to resist shifting or stretching. Stress on the laminate and joining sheets of the laminate is thereby reduced. Likewise, the tacky layer serves to maintain proper position of the laminate when various overlay or cladding materials are slid across or rub against the laminate during installation. The tacky layer can include various elastomers, metallocene-catalyzed polyolefin polymers, polyolefins, ethylene copolymer resins, vinyl acetates, styrene-ethylene/butylene-styrene block copolymers, thermoplastic polyurethanes, and mixtures thereof. To maintain water vapor permeability of the laminate, the tacky layer can be applied or fanned in various ways. For example, the tacky layer can be applied discontinuously to the scrim layer. Certain embodiments include where the tacky layer is formed with pores therethrough, such as by co-extrusion with a compressed gas as described for the bonding layer.

The flexible and water vapor permeable laminate according to the present technology can be coupled to a structure to provide a weather resistive barrier in various applications, including roofing and siding applications. The structure can include various types of buildings and edifices, such as residential units including single and multifamily units, commercial units, factories, and other industrial buildings. The laminate can be installed such that the tacky layer contacts the structure so that the laminate is resistant to moving or sliding on a surface of the structure. For example, the laminate can be coupled to a portion of a roof of the structure to serve as a roofing underlayment. The laminate can also be coupled to a portion of a wall of the structure to serve as a housewrap. In this way, the laminate can be used to protect the structure from incoming liquid water from precipitation or from exterior water condensation. The flexible property makes the laminate easy to install on structures and surfaces having various shapes and textures. The water vapor permeability property allows the laminate to have a high moisture vapor transmission rate, allowing portions of the structure to breathe and facilitating evaporation of any liquid water that finds its way into portions of the roof or walls of the structure.

The present technology provides several benefits and advantages, including the following. The laminate can be multi-purposed for use as housewrap and roofing underlayment. The flexibility allows the laminate to conform to various structure contours and profiles. The water vapor permeability allows the laminate to minimize water damage to a structure and subsequent growth of mold or mildew. The various layers of the laminate can each contribute to the water vapor permeability, where such layers as the bonding layer and the tacky layer can be made discontinuous or porous to maintain an effective moisture vapor transmission rate. The scrim layer can provide substantial reinforcement of the laminate and can impart substantially greater tear and stretch resistance than other housewraps or underlayments formed using a non-woven layer without a scrim layer. The tacky layer also makes the laminate easy to position on a structure and stay in place during subsequent installation of other building materials overtop of the laminate.

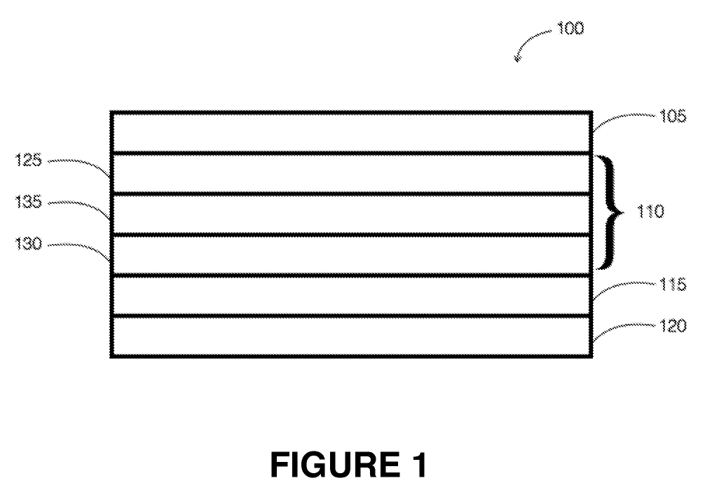

With reference to FIG. 1, an example of a laminate 100 constructed according to the present technology is shown in cross-section. The laminate 100 includes a non-woven layer 105, a bonding layer 110 contacting the non-woven layer 105, a scrim layer 115 contacting the bonding layer 100, and a tacky layer 120 contacting the scrim layer 115, where the laminate 100 is flexible and permeable to water vapor. In the example shown, the bonding layer 110 includes a first coating layer 125, a second coating layer 130, and a tie layer 135, where the tie layer 135 is intermediate the first coating layer 125 and the second coating layer 130. The tie layer 135 is configured as a second non-woven layer, which can include the same material as the non-woven layer 105 or can include a different material from the non-woven layer 105.

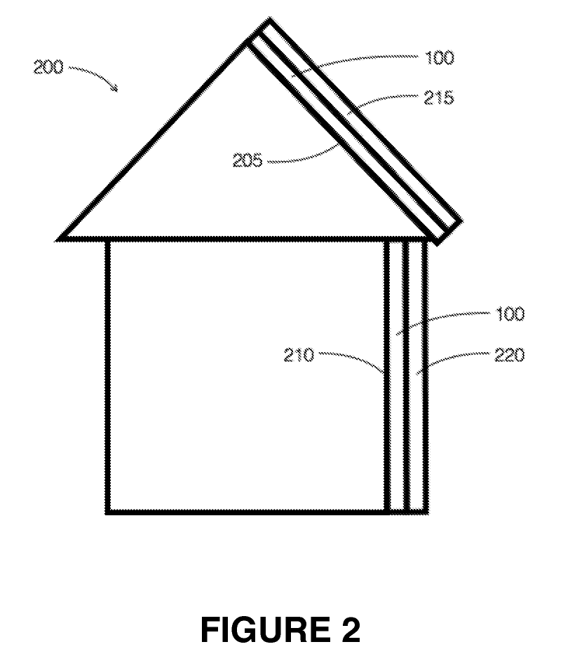

With reference to FIG. 2, an embodiment of the laminate 100 of FIG. 1 coupled to a structure 200 is shown. The laminate 100 can be coupled to at least a portion of a roof 205 of the structure 200 and can be coupled to at least a portion of a wall 210 of the structure 200. A roofing material 215 can be placed over the laminate 100 on the roof 205. Likewise, building siding 220 can be placed over the laminate 100 on the wall 210. In this way, the laminate 100 can protect the structure 200 from infiltration of liquid water, for example.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A laminate comprising:
a non-woven layer;
a bonding layer contacting the non-woven layer;
a scrim layer contacting the bonding layer; and
a tacky layer contacting the scrim layer;
wherein the laminate is flexible and permeable to water vapor.

2. The laminate of claim 1, wherein the non-woven layer includes a member selected from the group consisting of a spun bonded fiber, sheets of spun bonded-melt blown-spun bonded fibers, a perforated polymer film, an expanded polymer film, a microporous polymer film, and a paper.

3. The laminate of claim 1, wherein the non-woven layer includes a member selected from the group consisting of a polyolefin, a polyester, and combinations thereof.

4. The laminate of claim 1, wherein the bonding layer adheres the non-woven layer and the scrim layer together.

5. The laminate of claim 1, wherein the bonding layer includes a member selected from the group consisting of polyolefins, talcs, fillers, silicones and UV stabilizers.

6. The laminate of claim 1, wherein the bonding layer includes a first coating layer, a second coating layer, and a tie layer, the tie layer intermediate the first coating layer and the second coating layer.

7. The laminate of claim 5, wherein one of the first coating layer, the second coating layer, and the first coating layer and the second coating layer includes a member selected from the group consisting of polyolefins, talcs, fillers, silicones and UV stabilizers.

8. The laminate of claim 5, wherein the tie layer includes a member selected from the group consisting of polyolefins, talcs, fillers, silicones and UV stabilizers.

9. The laminate of claim 1, wherein the scrim layer includes a member selected from the group consisting of a polyolefin, a polyester, and combinations thereof.

10. The laminate of claim 1, wherein the scrim layer includes a coating on a surface thereof.

11. The laminate of claim 1, wherein the scrim layer is more resistant to tearing and stretching than the non-woven layer.

12. The laminate of claim 1, wherein the tacky layer includes a member selected from the group consisting of polyolefins, elastomers, and vinyl acetates.

13. The laminate of claim 1, wherein the tacky layer includes pores therethrough.

14. The laminate of claim 1, wherein the laminate has a surface density from about 100 grams per square meter to about 200 grams per square meter.

15. The laminate of claim 1, wherein the laminate is configured as a roll.

16. A structure comprising a laminate according to claim 1 coupled thereto.

17. The structure of claim 16, wherein the tacky layer is adjacent the structure.

18. The structure of claim 16, wherein the laminate is coupled to a member selected from the group consisting of a portion of a roof of the structure, a portion of a wall of the structure, and combinations thereof.

19. A method of protecting a structure comprising coupling a laminate according to claim 1 to the structure.

20. The method of claim 19, wherein the tacky layer is adjacent the structure.

21. The method of claim 19, wherein the laminate is coupled to a member selected from the group consisting of a portion of a roof of the structure, a portion of a wall of the structure, and combinations thereof.
